(19) United States
(12) Patent Application Publication
(10) Pub. No.: US 2025/0291465 A1
(43) Pub. Date: Sep. 18, 2025

(54) METHOD, APPARATUS, DEVICE AND STORAGE MEDIUM FOR MESSAGE PROCESSING

(71) Applicant: Beijing Zitiao Network Technology Co., Ltd., Beijing (CN)

(72) Inventors: Yuxuan ZHAO, Beijing (CN); Yumo TIAN, Beijing (CN)

(21) Appl. No.: 18/860,594

(22) PCT Filed: May 26, 2023
(86) PCT No.: PCT/CN2023/096502

§ 371 Date: Oct. 25, 2024

(30) Foreign Application Priority Data
May 31, 2022 (CN) 202210612156.X

(51) Int. Cl. G06F 3/0484; G06F 3/01

(52) U.S. Cl. CPC G06F 3/0484; G06F 3/017

(57) ABSTRACT

The embodiments of the disclosure disclose a method, an apparatus, a device and storage medium for message processing, and relate to the technical field of computers. The method includes: displaying a predetermined message identifier in a target interface, wherein at least one of predetermined media content and target resource information is presented in the target interface, and the predetermined message identifier is set to indicate that an unread message currently exists; and in response to a triggering operation of a for the predetermined message identifier, presenting a message interaction area in the target interface, and presenting the unread message sent by at least one sender in the message interaction area, wherein the message interaction area is set for message interaction between the current user and the at least one sender of a unread message.

### CROSS REFERENCE

This is a national stage application based on International Patent Application No. PCT/CN2023/096502, filed May 26, 2023, which claims priority to CN Patent Application No. 202210612156. X, filed on May 31, 2022, the entire contents of which are incorporated herein by reference in their entireties.

### FIELD

The embodiments of the present disclosure relates to the technical field of computers, in particular, to a method, an apparatus, a device and a storage medium for message processing.

### BACKGROUND

With the rapid development of Internet technologies and terminal technologies, functions provided by an application are becoming more and more rich, and when a user uses the application, the application may also receive new messages in a process of browsing a interface (hereinafter collectively referred to as a non-message interface) other than a message interface (for example, a message interaction interface, a message detail interface, and a message list interface).

### SUMMARY

The embodiments of the present disclosure provide a method, an apparatus, storage medium and device for message processing.

According to a first aspect, an embodiment of the present disclosure provides a method for message processing, including:
displaying a predetermined message identifier in a target interface of a predetermined application, wherein at least one of predetermined media content and target resource information is presented in the target interface, and the predetermined message identifier is set to indicate that an unread message currently exists; and
in response to a triggering operation of a current user for the predetermined message identifier, presenting a message interaction area in the target interface, and presenting the unread message sent by at least one sender in the message interaction area, wherein the message interaction area is provided for message interaction between the current user and the at least one sender of the unread message.

According to a second aspect, an embodiment of the present disclosure further provides an apparatus for message processing, including:
a message identifier displaying module configured to display a predetermined message identifier in a target interface of a predetermined application, wherein at least one of predetermined media content and target resource information is presented in the target interface, and the predetermined message identifier is set to indicate that an unread message currently exists; and
a message interaction area presentation module configured to show, in response to a triggering operation of a current user for the predetermined message identifier, a message interaction area in the target interface, and presenting the unread message sent by at least one sender in the message interaction area, wherein the message interaction area is provided for message interaction between the current user and the at least one sender of the unread message.

According to a third aspect, an embodiment of the present disclosure further provides an electronic device, including:
at least one processor;
a storage device configured to store at least one program, and
when the at least one program is executed by the at least one processor, the at least one processor implements the method for message processing provided by the embodiments of the present disclosure.

According to a fourth aspect, an embodiment of the present disclosure further provides a readable storage medium including a computer program, wherein the computer program, when executed by a computer processor, implements the method for message processing provided by the embodiments of the present disclosure.

### BRIEF DESCRIPTION OF DRAWINGS

FIG. 1 is a schematic flowchart of a method for message processing according to an embodiment of the present disclosure;

FIG. 2 is an interface interaction schematic diagram according to an embodiment of the present disclosure;

FIG. 3 is a schematic flowchart of another method for message processing according to an embodiment of the present disclosure;

FIG. 4 is an interface schematic diagram according to an embodiment of the present disclosure;

FIG. 5 is another interface interaction schematic diagram according to an embodiment of the present disclosure;

FIG. 6 is a schematic structural diagram of a message processing apparatus according to an embodiment of the present disclosure;

FIG. 7 is a schematic structural diagram of an electronic device according to an embodiment of the present disclosure.

### DETAILED DESCRIPTION

The term “comprising” used herein and variants thereof are non-exclusive inclusion, i.e., “including but not limited to”. The term “based on” is “based at least in part on”. The term “one embodiment” means “at least one embodiment”; the term “another embodiment” means “at least one another embodiment”; the term “some embodiments” means “at least some embodiments”. Related definitions of other terms will be given in the following description.

It should be noted that the concepts such as “first” and “second” mentioned in this disclosure are only used to distinguish different devices, modules, or units, and are not used to limit an order or an interdependency relationship of functions performed by these devices, modules, or units.

It should be noted that the modifications of “a” and “a plurality” mentioned in the present disclosure are illustrative rather than restrictive, and those skilled in the art should understand that they should be understood as “at least one” unless otherwise expressly stated in the context.

The names of messages or information exchanged between multiple devices in the embodiments of the present disclosure are only for illustration, and are not intended to limit the scope of these messages or information.

It may be understood that, before using the technical solutions disclosed in the various embodiments of the present disclosure, a user shall be informed of the type, application scope, and application scenario of the information involved in this disclosure in an appropriate manner and the relevant user's authorization shall be obtained, in accordance with relevant laws and regulations.

For example, in response to receiving an active request from a user, prompt information is sent to the user to explicitly prompt the relevant user that an operation requested by the user will require obtaining and use of personal information of the user. Thus, the user can autonomously select, according to the prompt information, whether to provide personal information to software or hardware such as an electronic device, an application program, a server, or a storage medium that executes the operations of the technical solutions of the present disclosure.

As an optional but non-limiting implementation, in response to receiving an active request from the user, prompt information is sent to the user, for example, in the form of a pop-up window, and the prompt information may be presented in the pop-up window in a form of text. In addition, the pop-up window may also carry a selection control for the user to select whether he/she “agrees” or “disagrees” to provide information to the electronic device.

It may be understood that the above notification and user authorization process are only illustrative, which do not limit the implementation of this disclosure. Other methods that meet relevant laws and regulations can also be applied to the implementation of this disclosure.

It shall be understood that data (including but not limited to data itself, data acquisition or use) involved in this technical solution should comply with requirements of corresponding laws and regulations and related regulations.

In a process of browsing a non-message interface, when an application receives a new message, a terminal wherein the application is located is typically notified to prompt the user in a manner such as vibration, and the user needs to perform a interface switching operation in order to view the unread message, which makes the operation process complicate and the interaction efficiency low.

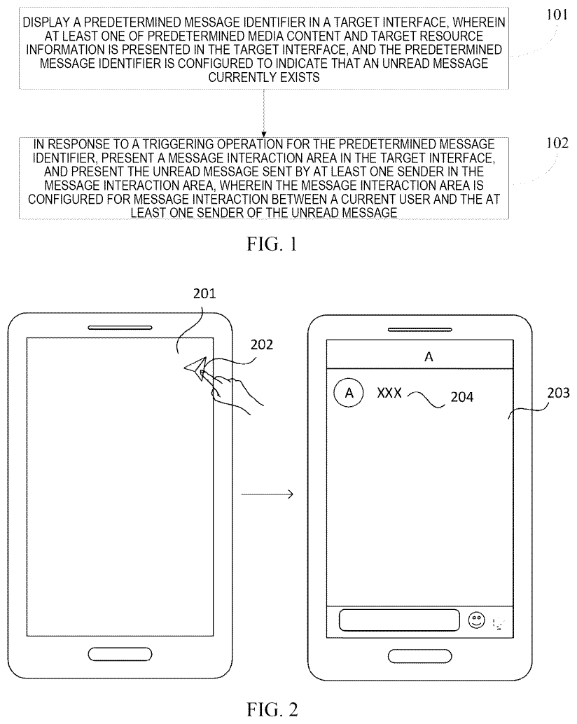

FIG. 1 is a schematic flowchart of a method for message processing provided by an embodiment of the present disclosure. The embodiments of the present disclosure is applicable to a case of message processing. The method may be executed by an apparatus for message processing, the apparatus may be implemented in a form of at least one of software and hardware, optionally, the apparatus may be implemented by an electronic device, and the electronic device may be a mobile terminal such as a mobile phone, a smart watch, a tablet computer, and a personal digital assistant, or may be a device such as a personal computer (PC) end or a server.

As shown in FIG. 1, the method includes:

At step 101, displaying a predetermined message identifier in a target interface of a predetermined application, wherein at least one of predetermined media content and target resource information is presented in the target interface, and the predetermined message identifier is set to indicate that an unread message currently exists.

In the embodiments of the present disclosure, the specific type of the predetermined application is not limited, for example, the predetermined application may be a video application, a live streaming application, a shopping application or an information application, or may be other types of applications. The target interface is configured to show at least one of predetermined media content and target resource information, the predetermined media content may be image content or video content, and specifically the predetermined media content may be a picture work, a video work, a live streaming, news, or a map, and the target resource information may include, for example, commodity introduction information or geographic location information. The target interface may be any interface in the predetermined application, or may be any interface in a predetermined interface set, which generally does not include a message interface, that is, the target interface may also be understood as a non-message interface. The present disclosure does not limit a specific type of the message, and it may be a conversation message, a notification message, or the like. The message interface may include, for example, a message interaction interface, a message detail interface, and a message list interface. The interface set may be determined according to a specific type of the predetermined application or other related factors. For example, the target interface may include a video playing interface, a video stream playing interface, a video detail interface, a shopping mall interface, a commodity detail interface, a video list interface, and the like.

For example, the predetermined message identifier is set to indicate that an unread message currently exists, the unread message may be specifically an unread message in a predetermined application. For example, when an unread message exists in the predetermined application, if the predetermined application is presenting the target interface, the predetermined message identifier is displayed in the target interface. Specific attribute information of the predetermined message identifier, such as a style, a shape, a size, and a display position in the target interface, is not limited and may be set according to an actual requirement.

FIG. 2 is an interface interaction schematic diagram provided by an embodiment of the present disclosure, for example, a predetermined message identifier 202 is displayed in an upper right corner of the target interface 201, and the predetermined message identifier 202 is configured to indicate that an unread message currently exists, wherein at least one of predetermined media content and target resource information shown in the target interface is not shown in FIG. 2, for example, video content may be shown in the target interface.

At step 102, presenting a message interaction area in the target interface in response to a triggering operation of a current user for the predetermined message identifier, and presenting the unread message sent by at least one sender in the message interaction area, wherein the message interaction area is provided for message interaction between the current user and the at least one sender of the unread message.

As an example, the current user may be understood as a user who is viewing the target interface, and the receiver of the unread message is the current user. A specific type of the triggering operation for the predetermined message identifier is not limited herein, for example, it may be a click or a long press. During the process of the current user viewing the predetermined media content in the target interface, if it is found that a predetermined message identifier is displayed in the target interface, it may be learned that an unread message currently exists, and if the current user wants to perform processing such as viewing or replying to the unread message, a triggering operation for the predetermined message identifier may be input.

As an example, after the current user triggers the predetermined message identifier, the message interaction area is presented in the target interface without interface jumping, wherein the showing manner is not limited. For example, the message interaction area may be shown within the target interface or on an upper layer of the target interface, and the size of the message interaction area may be less than or equal to the size of the target interface.

For example, the message interaction area is associated with a sender of the unread message, and the message interaction area is provided for the current user to perform message interaction with at least one sender. The unread message sent by the at least one sender is shown in the message interaction area, and the current user may view the unread message in the message interaction area, or may reply to the sender for the unread message in the message interaction area. The sender of the unread message may be another user other than the current user, may be a group conversation in which the current user participates, may be a system account of the predetermined application, or may be an Official Account, etc.

As shown in FIG. 2, assuming that the sender of the unread message is user A, after the current user triggers a predetermined message identifier 202, a message interaction area 203 corresponding to the user A may be shown, and the unread message 204 is shown in the message interaction area 203. If the current user wants to reply to the user A after reviewing the unread message 204, he or she can trigger the input box at the bottom of the message interaction area 203 to input message content in a form of text or voice, etc., so as to reply to user A.

According to the method for message processing provided by the embodiments of the present disclosure, a predetermined message identifier is displayed in a target interface of a predetermined application, at least one of predetermined media content and target resource information is presented in the target interface, and the predetermined message identifier is set to indicate that the unread message exists currently; and in response to a triggering operation of the current user for the predetermined message identifier, a message interaction area is presented in the target interface, and the unread message sent by the at least one sender is shown in the message interaction area, wherein the message interaction area is set for the current user to perform message interaction with at least one sender of the unread message. By adopting the technical solution, in a case that the unread message exists, the predetermined message identifier is displayed in the target interface which is presenting at least one of the predetermined media content and the target resource information, then the user can learn that the unread message exists currently through the predetermined message identifier, and if the user wants to view or reply to the unread message, the presentation of the message interaction area can be quickly triggered by triggering the predetermined message identifier without interface jumping, thus, the convenience of processing the unread message by the user is enhanced, and the message interaction efficiency is improved.

In some embodiments, there are at least two senders, and presenting a message interaction area in the target interface and presenting the unread message sent by at least one sender in the message interaction area includes: presenting a first message interaction area corresponding to a first sender in the target interface, and presenting an unread message sent by the first sender in the first message interaction area, wherein the first sender is determined according to a predetermined manner, and the first message interaction area is set for message interaction between the current user and the first sender. An advantage of such a setting lies in that when there are unread messages from a plurality of senders, a message interaction area corresponding to a sender that is currently preferentially shown may be determined according to a predetermined manner.

Optionally, the predetermined manner may be determined based on sending time of the unread message, for example, a sender corresponding to a latest received unread message is determined as the first sender; or the predetermined manner may be determined based on an association relationship between a sender and a current user, for example, a sender having a predetermined association relationship with the current user is preferentially determined as the first sender, and if there are a plurality of senders that meet the predetermined association relationship, the first sender may be then determined based on the sending time of the messages, or the first sender may be determined based on a sender priority predetermined by the current user.

In some embodiments, the message interaction area is located on an upper layer of the target interface, and a size of the message interaction area is smaller than a size of the target interface. An advantage of such a setting lies in that the change of content within the target interface is reduced, interface switching is not needed, the presentation of the message interaction area is added at the upper layer of the target interface, and thus the interaction efficiency is improved. Optionally, when the message interaction area is shown on the upper layer of the target interface, the display manner of an area in the target interface that is not blocked by the message interaction area may be adjusted, for example, a semi-transparent layer is added.

In some embodiments, when there are at least two senders, the method further includes: presenting a set of object identifiers in a target area of the target interface, wherein the target area is located outside of the message interaction area, and the set of object identifiers comprise an object identifier corresponding to at least one sender. The advantage of such a setting is to help the current user quickly and intuitively view the sender of the unread message.

For example, the set of object identifiers may include all senders corresponding to the unread messages, or may include all senders or some senders other than the first sender among all senders corresponding to the unread messages. For example, when there are two senders, it is assumed that the two senders are denoted as a first sender and a second sender, and the set of object identifiers may include the first sender and the second sender, or the set of object identifiers may include only the second sender. The object identifier may be an identifier used to indicate a sender. If the sender is a user, the object identifier may be a user identifier, and the user identifier may be a user name, a user nickname, a user avatar, or the like; if the sender is a group conversation, the object identifier may be an icon of the group conversation, or the like; and if the sender is a system or an official account, or the like, the object identifier may be an icon used to represent the system or the official account, or the like.

For example, if the unread messages of a user A and a user B currently exist, and the user A is the first sender, that is, the message interaction area currently shown is an interaction area between the current user and the user A, avatars of the user A and the user B may be shown in the target area, or only the avatar of the user B may be shown in the target area.

In some embodiments, the set of object identifiers includes a second object identifier and a first object identifier corresponding to the first sender, a first display manner for the first object identifier is different from a second display manner for the second object identifier, and the second object identifier comprises an object identifier other than the first object identifier in the set of object identifiers. The number of second object identifiers is not limited, which may be at least one. An advantage of such a setting lies in that, if the set of object identifiers includes both the first object identifier of the sender corresponding to the current message interaction area and an object identifier other than the first object identifier, to enable the current user to specify the current interaction object in the message interaction area, the first object identifier and the second object identifier may be displayed separately. Specific differences between the first display manner and the second display manner are not limited, for example, they may be displayed in different sizes, different shapes, different colors, or different transparency.

In some embodiments, the method further includes: presenting, in an associated area of the object identifier, the number of unread messages from a sender corresponding to the object identifier. The advantage of this setting is to help the current user intuitively know the number of unread messages respectively corresponding to each sender. The associated area of the object identifier may have an intersection with the display area of the object identifier, for example, it may be an upper right corner of the object identifier.

In some embodiments, the method further includes performing, in response to a first predetermined gesture operation by the current user on the target area, display adjustment on the set of object identifiers, the display adjustment including at least one of changing a display position of the object identifier, updating the object identifier, decreasing an object identifier, and increasing an object identifier. The first predetermined gesture operation may be, for example, a sliding operation, or a triggering operation on a specified control.

In some embodiments, the user may switch to show unread messages corresponding to different senders through gesture operations acting on the message interaction area or the target area. An advantage of this setting is that the interaction efficiency between the current user and different sending objects can be improved.

Optionally, the method may further include: switching, in response to a second predetermined gesture operation by the current user on a current message interaction area, the current message interaction area to a third message interaction area, where, a sender corresponding to the third message interaction area is different from a sender corresponding to the current message interaction area. The second predetermined gesture operation may be a sliding operation. For example, sliding to the left may switch to that the object identifier corresponding to the current message interaction area is in a message interaction area corresponding to the next object identifier in the set of object identifiers, that is, the object identifier corresponding to the third message interaction area is displayed after the object identifier corresponding to the current message interaction area; for another example, sliding to the right may switch to that the object identifier corresponding to the current message interaction area is in a message interaction area corresponding to the previous object identifier in the set of object identifiers, that is, the object identifier corresponding to the third message interaction area is displayed before the object identifier corresponding to the current message interaction area. It should be noted that cyclic switching may be implemented for the message interaction area, for example, in a case that the object identifier corresponding to the current message interaction area is the last object identifier, when sliding to the left, it may be switched to the message interaction area corresponding to the first object identifier.

Optionally, the method further includes: switching, in response to a third predetermined gesture operation by the current user on the target area, a current message interaction area to a fourth message interaction area, where, a sender corresponding to the fourth message interaction area is different from a sender corresponding to the current message interaction area. The third predetermined gesture operation may be a sliding operation. For example, a leftward sliding acting on the target area may have an effect of a leftward sliding acting on the current message interaction area, and details are not described herein again.

For example, the number of object identifiers displayed within the target area is less than or equal to a predetermined number threshold, and when the number of senders is relatively large and is greater than the predetermined number threshold (or the predetermined number threshold—1), the object identifiers cannot be completely displayed within the target area at a time, and the current user may view more object identifiers of the senders by using a gesture operation. For example, when the current user inputs the first sliding operation in the target area (optionally, the attribute of the sliding operation such as the sliding speed or the sliding start position may be different compared with that of the third predetermined gesture operation acting on target area for switching message interaction areas), the display position of the object identifier may change with the touch position of the current user on the screen (or the change of sliding distance); for another example, in the process of inputting the first sliding operation by the current user, the first object identifier pointed by the sliding direction may disappear with the increase of the sliding distance, and a new object identifier may be displayed in the reverse direction of the sliding direction; for another example, when the current user triggers a setting control such as “replacing a batch”, all currently displayed object identifiers may be replaced with object identifiers that have not been displayed.

In some embodiments, the method further includes: in response to a triggering operation for a target object identifier in the set of object identifiers, switching the first message interaction area to a second message interaction area, wherein the second message interaction area is set for message interaction between the current user and a sender corresponding to the target object identifier. An advantage of such a setting lies in that the current user can quickly switch to the corresponding message interaction area by triggering different object identifiers, thereby improving interaction efficiency.

In some embodiments, the method may further include: adjusting, in response to switching between message interaction areas, a display position of an object identifier corresponding to the switched message interaction area in the target area. The advantage of such a setting is that it can help the current user to know the current interaction object. For example, the object identifier corresponding to the switched message interaction area is displayed at a predetermined position in the target area, wherein the predetermined position may be, for example, a center position of the target area or a display position of the first object identifier. In some embodiments, when the switching between message interaction areas is triggered by a sliding gesture, the object identifiers may be correspondingly switched by sliding in the target area; when the switching between the message interaction areas is triggered by clicking, the object identifiers may be correspondingly switched by sliding in the target area, or the clicked object identifier may be adjusted to the predetermined position in the target area and the sequence of other object identifiers remains unchanged.

In some embodiments, displaying the predetermined message identifier in the target interface of the predetermined application includes: in response to detecting that an unread message exists in the predetermined application during the predetermined application presenting the target interface, displaying a predetermined message identifier in the target interface. The advantage of this setting is that in the process of presenting the target interface, it is detected whether an unread message exists in the predetermined application, and if yes, the predetermined message identifier is displayed in time to help the current user quickly learn that an unread message exists.

As an example, when entering the target interface, if it is detected that there is an unread message, the predetermined media content and the predetermined message identifier may be simultaneously displayed in the target interface; if it is detected that there is no unread message when entering the target interface, the predetermined media content is displayed in the target interface without displaying the predetermined message identifier; and then, if it is detected that a new message is received, the predetermined message identifier may be displayed.

In some embodiments, displaying the predetermined message identifier in the target interface includes: displaying a predetermined message identifier in a first predetermined area in the target interface, and adjusting a display area of a predetermined control from a second predetermined area to a third predetermined area, wherein the second predetermined area is associated with the first predetermined area. The advantage of this setting is that when a predetermined message identifier is additionally displayed in the target interface, a display area of a predetermined control being displayed at the display area associated with the display area of the predetermined message identifier is adjusted, so that the layout of the control in the interface is more reasonable. A way the second predetermined area is associated with the first predetermined area may be that the second predetermined area has an intersection with the first predetermined area, for example, the second predetermined area includes the first predetermined area. A size of the third predetermined area may be less than or equal to that of the second predetermined area, and there may be no intersection between the third predetermined area and the first predetermined area.

In some embodiments, the predetermined message identifier is set to indicate that an unread message of a predetermined message type currently exists. An advantage of this setting is that different types of unprocessed messages may be processed in a targeted manner, and if only unread messages other than those of the predetermined message type currently exist, the predetermined message identifier may not be displayed, thereby reducing interference to the current user when viewing the predetermined media content.

For example, a classification manner for the predetermined message type is not limited, and the classification manner may be set based on senders of the messages, or the classification manner may be set based on content of the messages, or the classification manner may be set based on the number of unread messages. After the classification manner is determined, the predetermined message type may be set by the predetermined application by default, or the predetermined message type may be set by the current user autonomously. For example, the predetermined application may set a sender of a unread message of the predetermined message type as the user, that is, if there is currently only a notification message sent by a system account, an official account, or the like, the predetermined message identifier may not be displayed; for another example, the current user may autonomously set a user sending the following unread messages as the sender: the unread messages are allowed to be reminded in a manner of displaying the predetermined message identifier. For example, a user having a predetermined association relationship with the current user is set as the sender of the unread message of the predetermined message type, and the predetermined association relationship may include, for example, following the current user, being followed by the current user, or being followed by each other or being a friend with the current user.

In some embodiments, the method may further include: presenting the number of the unread messages in an associated area of the predetermined message identifier. The advantage of such a setting is that it can help the current user to intuitively know more information related to the unread message, and determine whether to trigger the predetermined message identifier to process the unread message according to the number. The associated area of the predetermined message identifier may be, for example, a display area of the predetermined message identifier, or may be an area having an intersection with the display area of the predetermined message identifier, for example, an upper right corner area of the predetermined message identifier.

As an example, if the predetermined message identifier is set to indicate that there are currently unread messages of the predetermined message type, the number of unread messages of the predetermined message type may be displayed in the associated area of the predetermined message identifier.

In some embodiments, presenting the unread message sent by the at least one sender in the message interaction area includes: presenting, in the message interaction area, the unread message sent by the at least one sender and a historical interaction message corresponding to the at least one sender, wherein the historical interaction message includes a historical message interacted between the current user and the at least one sender. The advantage of such a setting is that it is convenient for the user to comprehensively know the historical interaction condition and thus improve the interaction efficiency. Optionally, after the historical interaction message and the unread message are displayed in the message interaction area, the current user may further browse more historical interaction messages that are not initially displayed in the message interaction area through gesture operations such as sliding (which may be downward sliding).

In some embodiments, the method further includes: after presenting the message interaction area in the target interface and presenting the unread message sent by the at least one sender in the message interaction area, canceling the presentation of the message interaction area, and resuming the presentation of the target interface in response to a close operation input by a current user for the message interaction area. An advantage of this setting is that after processing such as viewing or replying to the unread message, the current user can quickly return to the target interface to continue viewing the predetermined media content, so that the viewing experience of the media content and the message interaction requirement of the user can be well considered.

As an example, if the unread messages have been changed to “read” when the close operation is received, the predetermined message identifier is not displayed when the presentation of the target interface is resumed; and if some unread messages still exist when the close operation is received, the predetermined message identifier continues to be displayed when the presentation of the target interface is resumed. If the number of unread messages is displayed in the associated area of the predetermined message identifier, the number of unread messages will be updated.

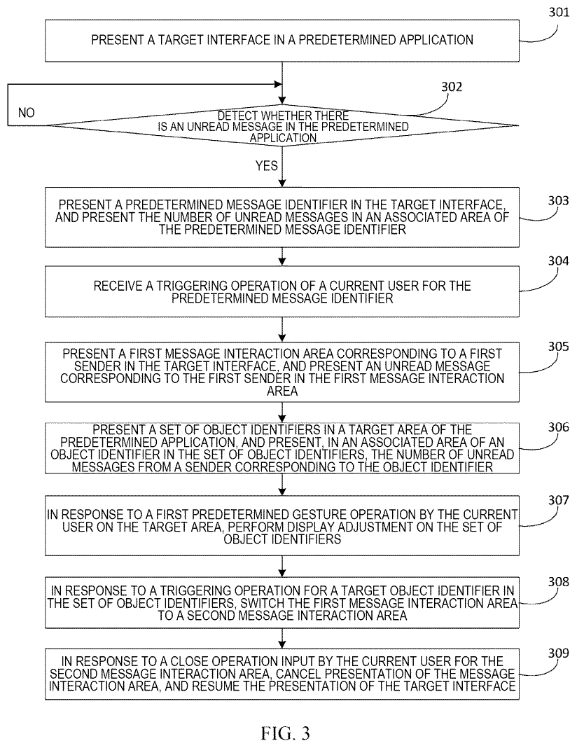

FIG. 3 is a schematic flowchart of another method for message processing according to an embodiment of the present disclosure. Embodiments of the present disclosure are described based on the optional solutions in the above embodiments, and the method includes the following steps:

At step 301, presenting a target interface in a predetermined application.

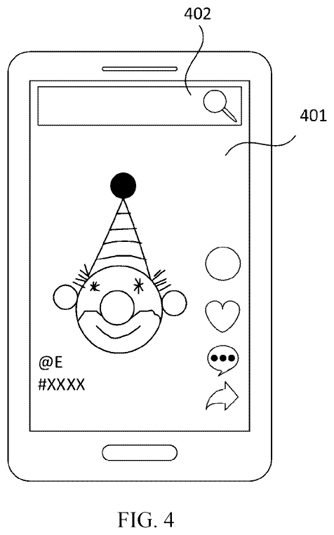

FIG. 4 is an interface schematic diagram provided by an embodiment of the present disclosure. As shown in FIG. 4, a target interface 401 is shown in a predetermined application, and predetermined multimedia content is presented in the target interface 401, such as a Clown video in FIG. 4, and an initial predetermined control 402 is further displayed on the top of the target interface 401.

At step 302, detecting whether there is an unread message in the predetermined application, and if the unread message exists, step 303 is performed; or if the unread message does not exist, step 302 will be repeated.

As an example, in the process of presenting the target interface in the predetermined application, it may be detected in real time or at a predetermined frequency whether an unread message exists in the predetermined application, wherein the unread message may be an unread message of a predetermined message type.

At step 303, displaying a predetermined message identifier in the target interface, and presenting the number of unread messages in an associated area of the predetermined message identifier.

If the unread message detected in the foregoing step is an unread message of a predetermined message type, the number of unread messages shown in the associated area of the predetermined message identifier may be a total number of unread messages of the predetermined message type.

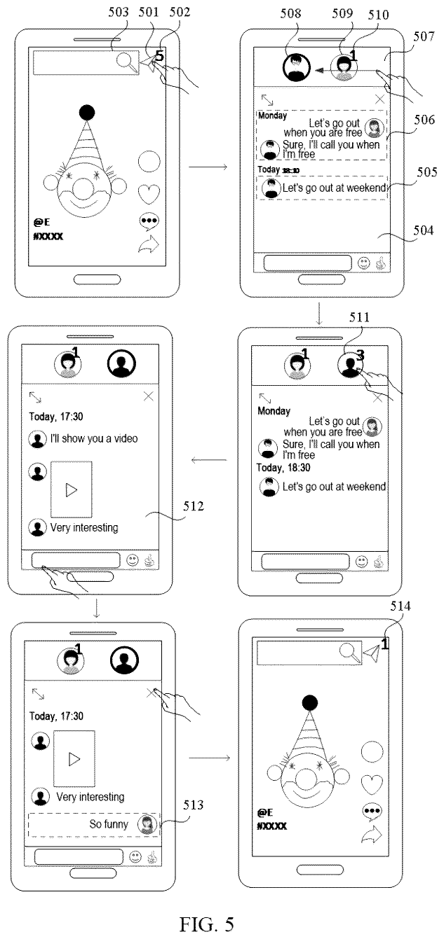

FIG. 5 is another interface interaction schematic diagram provided by an embodiment of the present disclosure, as shown in FIG. 5, a predetermined message identifier 501 is displayed in a target interface, and a quantity “5” 502 of unread messages is shown at an upper right corner of the predetermined message identifier 501.

Optionally, the predetermined message identifier may be displayed in a first predetermined area in the target interface, and the display area of the predetermined control is adjusted from a second predetermined area to a third predetermined area, wherein the second predetermined area and the first predetermined area have an intersection. Comparing FIG. 4 with FIG. 5, it can be obtained that the first display area of the predetermined message identifier 501 has an intersection with the second predetermined area of the initial predetermined control 402, and therefore, the display area of the initial predetermined control 402 can be adjusted, so that the display area of the adjusted predetermined control 503 is changed to the third predetermined area.

At step 304, receiving a triggering operation of a current user for a predetermined message identifier.

As an example, as shown in FIG. 5, in the process of watching the video, the current user finds that the number of unread messages has accumulated to 5, and if the user wants to view or reply to the unread messages, the predetermined message identifier 501 may be triggered in a manner such as clicking.

At step 305, presenting a first message interaction area corresponding to the first sender in the target interface, and presenting an unread message corresponding to the first sender in the first message interaction area.

As an example, the first message interaction area is set for message interaction between the current user and the first sender, and the first sender is determined according to a predetermined manner. If there is only one sender of the unread messages, the sender is determined as the first sender; if there are two or more senders of the unread messages, the first sender may be determined according to, for example, the receiving time of the unread messages, for example, the sender of the latest unread message is determined as the first sender. For example, the first message interaction area is located on an upper layer of the target interface, and a size of the first message interaction area is less than a size of the target interface.

As shown in FIG. 5, assuming that the user A is determined as the first sender, the first message interaction area 504 is displayed on the upper layer of the target interface, and 1 unread message 505 sent by the user A are shown in the first message interaction area 504. Optionally, the historical interaction message 506 between the user A and the current user may also be shown in the first message interaction area 504.

At step 306, presenting a set of object identifiers in a target area of the predetermined application, and presenting the number of unread messages from a sender corresponding to an object identifier in the set of object identifiers in an associated area of the object identifier.

The target area is located outside of the message interaction area, the set of object identifiers includes an object identifier corresponding to the sender, a first display manner for the first object identifier is different from a second display manner for the second object identifier, and the second object identifier comprises an object identifier other than the first object identifier in the set of object identifiers.

As shown in FIG. 5, the target area 507 is located above the first message interaction area 504, the set of object identifiers includes two object identifiers, which are respectively a first object identifier 508 of the user A (for example, an avatar of the user A) corresponding to the first message interaction area 504 and a second object identifier 509 of the user B (for example, an avatar of the user B), and the number “1” 510 of unread messages sent by the user B is shown at an upper right corner of the second object identifier 509. Since the unread messages 505 of the user A are already displayed in the first message interaction area 504, the number of unread messages is not displayed at the first object identifier 508. Compared with the second object identifier 509, the first object identifier 508 may be bolded to enhance the difference and facilitate the current user to quickly locate the current interactive object.

Optionally, the object identifier of the sender corresponding to the message interaction area currently being shown may not be displayed in the target area. For example, the first object identifier 508 may not be shown in the target area in FIG. 5. As an example, if there is only one sender for the unread message, the set of object identifiers may also be an empty set, that is, the object identifier is not displayed in the target area.

At step 307, performing display adjustment on the set of object identifiers in response to a first predetermined gesture operation performed by the current user on the target area.

The adjustment display includes at least one of changing a display position of the object identifier, updating the object identifier, decreasing an object identifier, and increasing an object identifier.

As shown in FIG. 5, the current user may input a leftward sliding operation, the first object identifier 508 moves out of the target area 507 along with sliding, the third object identifier 511 of the user C enters the target area 507 along with sliding, and the number “3” of unread messages sent by the user C is shown at the upper right corner of the third object identifier 511.

At step 308, switching the first message interaction area to the second message interaction area in response to a triggering operation for a target object identifier in the set of object identifiers.

The second message interaction area is set for the current user to perform message interaction with the sender corresponding to the target object identifier.

As shown in FIG. 5, the current user finds that the number of unread messages of the user C is big, so he/she may choose to view the unread messages of the user C first, and at this time, the third object identifier 511 (the target object identifier) may be triggered by clicking or the like, then the first message interaction area 504 is switched to the second message interaction area 512, and 3 unread messages of the user C are shown in the second message interaction area 512. The current user may reply to the user C based on the second message interaction area 512, and the reply message 513 is displayed in the second message interaction area after the reply is completed.

At step 309, in response to a close operation input by the current user for the second message interaction area, cancelling the presentation of the message interaction area, and resuming the presentation of the target interface.

As shown in FIG. 5, the current user inputs a close operation for the second message interaction area in a manner of clicking a close button, then the second message interaction area is closed, and the presentation of the target interface is resumed, thus the current user can continue to watch the Clown video. In this case, because the unread message of the user B is not viewed by the current user, there are still 1 unread message, and the display of the predetermined message identifier may be retained, and the number at the upper right corner may be updated to “1”.

According to the message processing method provided by the embodiments of the invention, in the process of displaying the target interface by the predetermined application, if an unread message is detected, the predetermined message identifier and the number of the unread messages are displayed, and after the current user triggers the predetermined message identifier, the message interaction area is shown on the upper layer of the target interface; the unread message is shown in the message interaction area, and the set of object identifiers is shown outside of the message interaction area, so that the user can conveniently switch the sending object having unread message needed to be processed, and the user can quickly return to the target interface to continue to view the predetermined media content after closing the message interaction area. By adopting the technical scheme, in the process of viewing the predetermined media content in the target interface, the user can visually and conveniently know the condition of the unread message, can quickly show the message interaction area when the unread message needs to be processed, can interact with the sender of the unread message without switching the interface, supports rapid switching of the sender, enhances the convenience of processing the unread message by the user, improves the message interaction efficiency, and can quickly return to the target interface to continue to view the predetermined media content, so that the watching experience of the media content and the message interaction requirement of the user can be well considered.

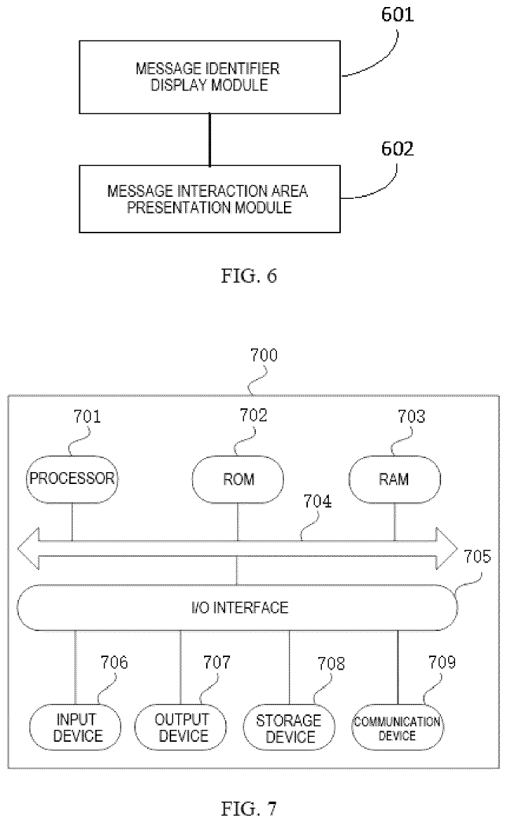

FIG. 6 is a schematic structural diagram of an apparatus for message processing according to an embodiment of the present disclosure. As shown in FIG. 6, the apparatus includes: a message identifier displaying module 601 and a message interaction area presentation module.

The message identifier displaying module 601 is configured to display a predetermined message identifier in a target interface of a predetermined application, wherein at least one of predetermined media content and target resource information is presented in the target interface, and the predetermined message identifier is set to indicate that an unread message currently exists.

The message interaction area presentation module 602 is configured to show, in response to a triggering operation of a current user for the predetermined message identifier, a message interaction area in the target interface, and presenting the unread message sent by at least one sender in the message interaction area, wherein the message interaction area is provided for message interaction between the current user and the at least one sender of the unread message.

According to the apparatus for message processing provided by the embodiments of the invention, a predetermined message identifier is displayed in a target interface of a predetermined application, at least one of predetermined media content and target resource information is presented in the target interface, and the predetermined message identifier is set to indicate that the unread message exists currently; and in response to a triggering operation of the current user for the predetermined message identifier, a message interaction area is presented in the target interface, and the unread message sent by the at least one sender is shown in the message interaction area, wherein the message interaction area is provided for the current user to perform message interaction with at least one sender of the unread message. By adopting the technical solution, in a case that the unread message exists, the predetermined message identifier is displayed in the target interface which is presenting at least one of the predetermined media content and the target resource information, the user can learn that the unread message exists currently through the predetermined message identifier, and if the user wants to view or reply to the unread message, the presentation of the message interaction area can be quickly triggered by triggering the predetermined message identifier without jumping to the interface, thus, the convenience of processing the unread message by the user is enhanced, and the message interaction efficiency is improved.

Optionally, when there are at least two senders, presenting a message interaction area in the target interface and presenting the unread message sent by at least one sender in the message interaction area includes:
presenting a first message interaction area corresponding to a first sender in the target interface, and presenting an unread message sent by the first sender in the first message interaction area, wherein the first sender is determined according to a predetermined manner, and the first message interaction area is set for message interaction between the current user and the first sender.

Optionally, the message interaction area is located on an upper layer of the target interface, and a size of the message interaction area is smaller than a size of the target interface.

Optionally, the apparatus further includes:
a set of object identifiers showing module configured to show a set of object identifiers in a target area of the target interface in a case that there are at least two senders, wherein the target area is located outside of the message interaction area, and the set of object identifiers comprise an object identifier corresponding to at least one sender.

Optionally, the set of object identifiers includes a first object identifier corresponding to the first sender, a first display manner for the first object identifier is different from a second display manner for a second object identifier, and the second object identifier includes an object identifier other than the first object identifier in the set of object identifiers.

Optionally, the apparatus further includes:
a first number presentation module configured to show, in the associated area of the object identifier, the number of unread messages from the sender corresponding to the object identifier.

Optionally, the apparatus further includes:
a display adjusting module configured to perform display adjustment on the set of object identifiers in response to a first predetermined gesture operation by the current user on the target area, the display adjustment including at least one of changing a display position of the object identifier, updating the object identifier, decreasing an object identifier, and increasing an object identifier.

Optionally, the apparatus further includes:
a first switching module configured to switch the first message interaction area to a second message interaction area in response to a triggering operation for a target object identifier in the set of object identifiers, wherein the second message interaction area is set for message interaction between the current user and a sender corresponding to the target object identifier.

Optionally, the apparatus further includes:
a second switching module configured to switch the current message interaction area to a third message interaction area in response to a second predetermined gesture operation by the current user on a current message interaction area, wherein a sender corresponding to the third message interaction area is different from a sender corresponding to the current message interaction area.

Optionally, the apparatus further includes:
a third switching module configured to switch a current message interaction area to a fourth message interaction area in response to a third predetermined gesture operation by the current user on the target area, wherein a sender corresponding to the fourth message interaction area is different from a sender corresponding to the current message interaction area.

Optionally, the apparatus further includes:
a display position adjusting module configured to adjust, in response to switching between message interaction areas, a display position of an object identifier corresponding to the switched message interaction area in the target area.

Optionally, the message identifier displaying module is configured to:
in response to detecting that there are unread messages in the predetermined application in a process of the present application presenting the target interface, display a predetermined message identifier in the target interface.

Optionally, displaying the predetermined message identifier in the target interface includes:
displaying a predetermined message identifier in a first predetermined area in the target interface, and adjusting a display area of a predetermined control from a second predetermined area to a third predetermined area, wherein the second predetermined area is associated with the first predetermined area.

Optionally, the predetermined message identifier is set to indicate that an unread message of a predetermined message type currently exists.

Optionally, the apparatus further includes:
a second number displaying module, configured to display the number of the unread messages in an associated area of the predetermined message identifier.

Optionally, displaying the unread message sent by at least one sender in the message interaction area includes:
presenting, in the message interaction area, the unread message sent by the at least one sender and a historical interaction message corresponding to the at least one sender, wherein the historical interaction message includes a historical message interacted between the current user and the at least one sender.

Optionally, the apparatus further includes:
a presentation canceling module configured to cancel, after presenting the message interaction area in the target interface and presenting the unread message sent by the at least one sender in the message interaction area and in response to a close operation input by the current user for the message interaction area, the presentation of the message interaction area, and resuming the presentation of the target interface.

The apparatus for message processing provided by the embodiments of the present disclosure may execute the method for message processing provided by any embodiment of the present disclosure, and has corresponding functional modules and effects for executing the method.

FIG. 7 is a structural schematic diagram of an electronic device provided in an embodiment of the present disclosure. Referring to FIG. 7 below, FIG. 7 is a structural schematic diagram of an electronic device (such as the terminal device or server in FIG. 7) 700 suitable for implementing the embodiments of the present disclosure. The terminal device 700 in the embodiments of the present disclosure may include but is not limited to mobile terminals such as mobile phones, laptops, digital broadcast receivers, Personal Digital Assistants (PDA), tablet computers (PADs), portable multimedia players (PMPs), vehicle-mounted terminals (such as car navigation terminals), etc. and fixed terminals such as digital TV, desktop computers, etc. The electronic device shown in FIG. 7 is only an example and should not bring any limitation on the functionality and scope of use of the embodiments of the present disclosure.

As shown in FIG. 7, the electronic device 700 may include a processor (such as a central processing unit, graphics processing unit, etc.) 701, and the processor 701 may perform various appropriate actions and processes based on programs stored in Read-Only Memory (ROM) 702 or loaded from storage device 508 into Random Access Memory (RAM) 703. In the RAM 703, various programs and data necessary for the operation of the electronic device 700 are also stored. The processor 701, ROM 702, and RAM 703 are connected to each other through a bus 704. An Input/Output (I/O) interface 705 is also connected to the bus 704.

Typically, the following devices can be connected to I/O interface 705: input devices 706 including, for example, touch screens, touchpads, keyboards, mice, cameras, microphones, accelerometers, gyroscopes, etc.; output devices 707 including liquid crystal displays (LCDs), speakers, vibrators, etc.; storage devices 708 including magnetic tapes, hard disks, etc.; and a communication device 709. The communication device 709 may allow the electronic device 700 to communicate with other devices wirelessly or wirelessly to exchange data. Although FIG. 7 shows an electronic device 700 with a plurality of devices, it shall be understood that it is not required to implement or have all of the devices shown. More or fewer devices can be implemented or provided instead.

In particular, according to embodiments of the present disclosure, the process described above with reference to the flowchart can be implemented as a computer software program. For example, an embodiment of the present disclosure includes a computer program product that includes a computer program carried on a non-transitory computer-readable medium, wherein the computer program includes program code for performing the method shown in the flowchart. In such an embodiment, the computer program can be downloaded and installed from a network through the communication device 709, or installed from the storage device 708, or installed from the ROM 702. When the computer program is executed by the processing device 701, the above functions defined in the method of the embodiments of the present disclosure are performed.

The electronic device provided in this embodiment of the present disclosure and the method for message processing in an application provided in the above embodiments belongs to the invention idea. Technical details that are not described in detail in this embodiment can be found in the above embodiments, and this embodiment has the same effect as the above embodiments.

An embodiment of the present disclosure provides a computer readable storage medium on which a computer program is stored, when being executed by a processor, the program implements the method for message processing in an application provided in the above embodiments.

It should be noted that the computer-readable storage medium described above can be a computer-readable signal medium or a computer-readable storage medium, or any combination thereof. The computer-readable storage medium can be, for example, but not limited to, an electrical, magnetic, optical, electromagnetic, infrared, or semiconductor system, apparatus, or device, or any combination thereof. Examples of computer-readable storage media may include but are not limited to: an electrical connection with at least one wire, a portable computer disk, a hard disk, random access memory (RAM), read-only memory (ROM), an erasable programmable read-only memory (EPROM or flash memory), an optical fiber, a portable compact disk read-only memory (CD-ROM), an optical storage device, a magnetic storage device, or any suitable combination thereof. In the present disclosure, a computer-readable storage medium may be any tangible medium containing or storing a program that can be used by an instruction execution system, apparatus, or device, or can be used in combination with an instruction execution system, apparatus, or device. In the present disclosure, a computer-readable signal medium can include a data signal propagated in baseband or as part of a carrier wave, which carries computer-readable program code therein. Such propagated data signals may take many forms, including but not limited to electromagnetic signals, optical signals, or any suitable combination thereof. A computer-readable signal medium may also be any computer-readable storage medium other than a computer-readable storage medium, which can send, propagate, or transmit programs for use by or in conjunction with instruction execution systems, apparatus, or devices. The program code contained on the computer-readable storage medium may be transmitted using any suitable medium, including but not limited to: wires, optical cables, radio frequency (RF), etc., or any suitable combination thereof.

In some embodiments, clients and servers can communicate using any currently known or future developed network protocol such as HyperText Transfer Protocol (HTTP), and can be interconnected with any form or medium of digital data communication (such as communication networks). Examples of communication networks include local area networks (“LANs”), wide area networks (“WANs”), internetworks (such as the Internet), and end-to-end networks (such as ad hoc end-to-end networks), as well as any currently known or future developed networks.

The computer-readable storage medium can be included in the electronic device, or it can exist alone without being assembled into the electronic device.

The above-mentioned computer-readable medium carries one or more programs, and when the above-mentioned one or more programs are executed by the electronic device, the electronic device: display a predetermined message identifier in a target interface of a predetermined application, wherein at least one of predetermined media content and target resource information is presented in the target interface, and the predetermined message identifier is set to indicate that an unread message currently exists; and in response to a triggering operation of a current user for the predetermined message identifier, show a message interaction area in the target interface, and presenting the unread message sent by at least one sender in the message interaction area, wherein the message interaction area is provided for message interaction between the current user and the at least one sender of the unread message.

Computer program codes for performing the operations of the present disclosure may be written in at least one programming languages or a combination thereof, including but not limited to Object Oriented programming languages-such as Java, Smalltalk, C++, and also conventional procedural programming languages-such as “C” or similar programming languages. The program code may be executed entirely on the user's computer, partially executed on the user's computer, executed as a standalone software package, partially executed on the user's computer and partially on a remote computer, or entirely on a remote computer or server. In the case of involving a remote computer, the remote computer may be any kind of network—including local area network (LAN) or wide area network (WAN)—connected to the user's computer, or may be connected to an external computer (e.g., through an Internet service provider to connect via the Internet).

The flowcharts and block diagrams in the accompanying drawings illustrate the architecture, functions, and operations of possible implementations of the system, method, and computer program product according to various embodiments of the present disclosure. In this regard, each block in a flowchart or block diagram may represent a module, program segment, or portion of code that contains at least one of executable instructions for implementing a specified logical function. It should also be noted that in some alternative implementations, the functions marked in the blocks may occur in a different order than those marked in the drawings. For example, two consecutive blocks may actually be executed in parallel, or they may sometimes be executed in reverse order, depending on the function involved. It should also be noted that each block in the block diagrams and/or flowcharts, as well as combinations of blocks in the block diagrams and/or flowcharts, may be implemented using a dedicated hardware-based system that performs the specified function or operations, or may be implemented using a combination of dedicated hardware and computer instructions.

The modules described in the embodiments of the present disclosure may be implemented by means of software or hardware, and the name of the module does not constitute a limitation on the module itself in a certain case, for example, the message identifier displaying module may also be described as “a module for displaying a predetermined message identifier in a target interface of a predetermined application, wherein at least one of predetermined media content and target resource information is presented in the target interface, and the predetermined message identifier is set to indicate that an unread message currently exists”.

The functions described herein above can be performed at least in part by at least one hardware logic components. For example, without limitation, example types of hardware logic components that may be used include: Field Programmable Gate Arrays (FPGAs), Application Specific Integrated Circuits (ASICs), Application Specific Standard Parts (ASSPs), System on Chip (SOCs), Complex Programmable Logic Devices (CPLDs), and so on.

In the context of this disclosure, a machine-readable storage medium can be a tangible medium that may contain or store programs for use by or in conjunction with instruction execution systems, apparatuses, or devices. A machine-readable storage medium may be a machine-readable signal medium or a machine-readable storage medium. A machine-readable storage medium may include, but are not limited to, electronic, magnetic, optical, electromagnetic, infrared, or semiconductor systems, apparatuses, or devices, or any suitable combination thereof. Examples of the machine-readable storage medium may include electrical connections based on at least one wires, portable computer disks, hard disks, random access memory (RAM), read-only memory (ROM), erasable programmable read-only memory (EPROM or flash memory), optical fibers, convenient compact disk read-only memory (CD-ROM), optical storage devices, magnetic storage devices, or any suitable combination thereof.

According to at least one embodiment of the present disclosure, Example 1 provides a method for message processing, including:
displaying a predetermined message identifier in a target interface of a predetermined application, wherein at least one of predetermined media content and target resource information is presented in the target interface, and the predetermined message identifier is set to indicate that an unread message currently exists; and
in response to a triggering operation of a current user for the predetermined message identifier, presenting a message interaction area in the target interface, and presenting the unread message sent by at least one sender in the message interaction area, wherein the message interaction area is provided for message interaction between the current user and the at least one sender of the unread message.

According to at least one embodiment of the present disclosure, in the method according to example 1, when there are at least two senders, and presenting a message interaction area in the target interface and presenting the unread message sent by at least one sender in the message interaction area includes:
presenting a first message interaction area corresponding to a first sender in the target interface, and presenting an unread message sent by the first sender in the first message interaction area, wherein the first sender is determined according to a predetermined manner, and the first message interaction area is set for message interaction between the current user and the first sender.

According to at least one embodiment of the present disclosure, in the method according to example 2, the message interaction area is located on an upper layer of the target interface, and a size of the message interaction area is smaller than a size of the target interface.

According to at least one embodiment of the present disclosure, in the method of example 4 according to example 2,
in a case that there are at least two senders, the method further includes:
presenting a set of object identifiers in a target area of the target interface, wherein the target area is located outside of the message interaction area, and the set of object identifiers comprise an object identifier corresponding to at least one sender.

According to at least one embodiment of the present disclosure, in the method of example 5 according to example 4, the set of object identifiers includes a first object identifier corresponding to the first sender and a second object identifier, a first display manner for the first object identifier is different from a second display manner for the second object identifier, and the second object identifier comprises an object identifier other than the first object identifier in the set of object identifiers.

According to at least one embodiment of the present disclosure, the method of example 6 according to example 4 further includes:
presenting, in an associated area of the object identifier, the number of unread messages from a sender corresponding to the object identifier.

According to at least one embodiment of the present disclosure, the method of example 7 according to example 4 further includes:
in response to a first predetermined gesture operation by the current user on the target area, performing display adjustment on the set of object identifiers, the display adjustment including at least one of changing a display position of the object identifier, updating the object identifier, decreasing an object identifier, and increasing an object identifier.

According to at least one embodiment of the present disclosure, the method of example 8 according to example 4 further includes:
in response to a triggering operation for a target object identifier in the set of object identifiers, switching the first message interaction area to a second message interaction area, wherein the second message interaction area is set for message interaction between the current user and a sender corresponding to the target object identifier.

According to at least one embodiment of the present disclosure, the method of example 9 according to example 4 further includes:
in response to a second predetermined gesture operation by the current user on a current message interaction area, switching the current message interaction area to a third message interaction area, wherein a sender corresponding to the third message interaction area is different from a sender corresponding to the current message interaction area.

According to at least one embodiment of the present disclosure, the method of example 10 according to example 4 further includes:
in response to a third predetermined gesture operation by the current user on the target area, switching a current message interaction area to a fourth message interaction area, wherein a sender corresponding to the fourth message interaction area is different from a sender corresponding to the current message interaction area.

According to at least one embodiment of the present disclosure, the method of example 11 according to any one of examples 8 to 10 further includes:
in response to switching between message interaction areas, adjusting a display position of an object identifier corresponding to the switched message interaction area in the target area.

According to at least one embodiment of the present disclosure, in the method of example 12 according to example 1, displaying the predetermined message identifier in the target interface of the predetermined application includes:
in response to detecting that there are unread messages in the predetermined application in a process of the present application presenting the target interface, displaying a predetermined message identifier in the target interface.

According to at least one embodiment of the present disclosure, in the method of example 13 according to example 12, displaying the predetermined message identifier on the target interface includes:
displaying a predetermined message identifier in a first predetermined area in the target interface, and adjusting a display area of a predetermined control from a second predetermined area to a third predetermined area, wherein the second predetermined area is associated with the first predetermined area.

According to at least one embodiment of the present disclosure, in the method of example 14 according to example 1, the predetermined message identifier is set to indicate that an unread message of a predetermined message type currently exists.

According to at least one embodiment of the present disclosure, the method of example 15 according to example 1 further includes:
presenting the number of the unread messages in an associated area of the predetermined message identifier.

According to at least one embodiment of the present disclosure, in the method of example 16 according to example 1, presenting the unread message sent by the at least one sender in the message interaction area includes:
presenting, in the message interaction area, the unread message sent by the at least one sender and a historical interaction message corresponding to the at least one sender, wherein the historical interaction message includes a historical message interacted between the current user and the at least one sender.

According to at least one embodiment of the present disclosure, the method of example 17 according to example 1 further includes, after presenting the message interaction area in the target interface and presenting the unread message sent by the at least one sender in the message interaction area:
in response to a close operation input by the current user for the message interaction area, canceling the presentation of the message interaction area, and resuming the presentation of the target interface.

According to at least one embodiment of the present disclosure, example 18 provides an apparatus for message processing, including:
a message identifier displaying module configured to display a predetermined message identifier in a target interface of a predetermined application, wherein at least one of predetermined media content and target resource information is presented in the target interface, and the predetermined message identifier is set to indicate that an unread message currently exists; and
a message interaction area presentation module configured to show, in response to a triggering operation of a current user for the predetermined message identifier, a message interaction area in the target interface, and presenting the unread message sent by at least one sender in the message interaction area, wherein the message interaction area is provided for message interaction between the current user and the at least one sender of the unread message.

In accordance with at least one embodiment of the present disclosure, the apparatus of example 17 according to example 1 further includes, means for performing the method of any of examples 2 to 17.

Example 20 provides an electronic device, including:
at least one processor;
a storage device configured to store at least one program, wherein
the at least one program, when executed by the at least one processor, causes the at least one processor to implement the method for message processing provided by the embodiments of the present disclosure.

According to one or more embodiments of the present disclosure, Example 21 provides a storage medium including computer executable instructions which, when executed by a computer processor, implement the method for message processing provided by the embodiments of the present disclosure.

1. A method for message processing, comprising:
displaying a predetermined message identifier in a target interface, wherein at least one of predetermined media content and target resource information is presented in the target interface, and the predetermined message identifier is set to indicate that an unread message currently exists; and
in response to a triggering operation for the predetermined message identifier, presenting a message interaction area in the target interface, and presenting the unread message sent by at least one sender in the message interaction area, wherein the message interaction area is set for message interaction between a current user and the at least one sender of the unread message.

2. The method of claim 1, wherein a number of the sender is at least two, and presenting the message interaction area in the target interface and presenting the unread message sent by at least one sender in the message interaction area comprises:
presenting a first message interaction area corresponding to a first sender in the target interface, and presenting an unread message sent by the first sender in the first message interaction area, wherein the first sender is determined according to a predetermined manner, and the first message interaction area is set for message interaction between the current user and the first sender.

3. The method of claim 1, wherein the message interaction area is located on an upper layer of the target interface, and a size of the message interaction area is smaller than a size of the target interface.

4. The method of claim 2, further comprising:
presenting a set of object identifiers in a target area of the target interface, wherein the target area is located outside of the message interaction area, and the set of object identifiers comprise an object identifier corresponding to at least one sender.

5. The method of claim 4, wherein the set of object identifiers comprises a second object identifier and a first object identifier corresponding to the first sender, wherein a first display manner for the first object identifier is different from a second display manner for the second object identifier, and the second object identifier comprises an object identifier other than the first object identifier in the set of object identifiers.

6. The method of claim 4, further comprising:
presenting, in an associated area of the object identifier, the number of unread messages from a sender corresponding to the object identifier.

7. The method of claim 4, further comprising:
in response to a first predetermined gesture operation by the current user on the target area, performing display adjustment on the set of object identifiers, wherein the display adjustment comprises at least one of changing a display position of the object identifier, updating the object identifier, decreasing an object identifier, and increasing an object identifier.

8. The method of claim 4, further comprising:
in response to a triggering operation for a target object identifier in the set of object identifiers, switching the first message interaction area to a second message interaction area, wherein the second message interaction area is set for message interaction between the current user and a sender corresponding to the target object identifier.

9. The method of claim 4, further comprising:
in response to a second predetermined gesture operation by the current user on a current message interaction area, switching the current message interaction area to a third message interaction area, wherein a sender corresponding to the third message interaction area is different from a sender corresponding to the current message interaction area.

10. The method of claim 4, further comprising:
in response to a third predetermined gesture operation by the current user on the target area, switching a current message interaction area to a fourth message interaction area, wherein a sender corresponding to the fourth message interaction area is different from a sender corresponding to the current message interaction area.

11. The method of claim 8, further comprising:
in response to switching between message interaction areas, adjusting a display position of an object identifier corresponding to the switched message interaction area in the target area.

12. The method of claim 1, wherein displaying the predetermined message identifier in the target interface of the predetermined application comprises:
in response to detecting that an unread message exists in the predetermined application during the predetermined application presenting the target interface, displaying the predetermined message identifier in the target interface.

13. The method of claim 12, wherein displaying the predetermined message identifier in the target interface comprises:
displaying the predetermined message identifier in a first predetermined area in the target interface, and adjusting a display area of a predetermined control from a second predetermined area to a third predetermined area, wherein the second predetermined area is associated with the first predetermined area.

14. The method of claim 1, wherein the predetermined message identifier is set to indicate that an unread message of a predetermined message type currently exists.

15. The method of claim 1, further comprising:
presenting the number of the unread messages in an associated area of the predetermined message identifier.

16. The method of claim 1, wherein presenting the unread message sent by the at least one sender in the message interaction area comprises:
presenting, in the message interaction area, the unread message sent by the at least one sender and a historical interaction message corresponding to the at least one sender, wherein the historical interaction message comprises a historical message interacted between the current user and the at least one sender.

17. The method of claim 1, wherein the method further comprises, after presenting the message interaction area in the target interface and presenting the unread message sent by the at least one sender in the message interaction area:
in response to a close operation input by the current user for the message interaction area, canceling the presentation of the message interaction area, and resuming the presentation of the target interface.

18-19. (canceled)

20. An electronic device, comprising:
at least one processor;
a storage device configured to store at least one program,
wherein the at least one program, when executed by the at least one processor, causes the at least one processor to implement a method comprising:
displaying a predetermined message identifier in a target interface, wherein at least one of predetermined media content and target resource information is presented in the target interface, and the predetermined message identifier is set to indicate that an unread message currently exists; and
in response to a triggering operation for the predetermined message identifier, presenting a message interaction area in the target interface, and presenting the unread message sent by at least one sender in the message interaction area, wherein the message interaction area is set for message interaction between a current user and the at least one sender of the unread message.

21. A non-transitory readable storage medium containing a computer program which, when executed by a computer processor, implements a method comprising:
displaying a predetermined message identifier in a target interface, wherein at least one of predetermined media content and target resource information is presented in the target page interface, and the predetermined message identifier is set to indicate that an unread message currently exists; and
in response to a triggering operation for the predetermined message identifier, presenting a message interaction area in the target interface, and presenting the unread message sent by at least one sender in the message interaction area, wherein the message interaction area is set for message interaction between a current user and the at least one sender of the unread message.
